(19) United States
(12) Patent Application Publication
(10) Pub. No.: US 2012/0098493 A1
(43) Pub. Date: Apr. 26, 2012

(54) CHARGING STATION

(76) Inventor: Lothar Budike, Vilanova, PA (US)

(21) Appl. No.: 13/277,173

(22) Filed: Oct. 19, 2011

Related U.S. Application Data
(60) Provisional application No. 61/405,892, filed on Oct. 22, 2010.

(51) Int. Cl. H02J 7/00; H02J 7/02

(52) U.S. Cl. 320/111; 320/107

(57) ABSTRACT

The invention is a a charging station that includes a base having a housing with at least one receptacle that is adapted to be connected to an external power source, with an outer cover being connected to the base and having a holder for one or more devices which need recharging. The cover has a wave-shaped form which holds one or more devices which require charging in one or more wave-like supports on the cover. A slot is provided at the base of each wave-shaped support for receiving the device adapter plug, and a space is defined beneath the outer cover that allows the charger nut connected to the receptacle to be covered by the outer cover when it is in a closed position. A cord organizer is provided with each receptacle so that the excess cord from the charger can be stored in a compact and efficient manner.

### CROSS-REFERENCES TO RELATED APPLICATIONS (IF ANY)

This is a non-provisional application claiming priority of the provisional application 61/405,892 filed Oct. 22, 2010.

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a charging station; more having a base having a housing with at least one receptacle that is adapted to be connected to an external power source intervals.

2. Background

Portable electronic devices that require periodic charging are becoming increasingly popular. These include, for example, cell phones, MP3 players, portable gaming devices, tablet PC's as well as various other devices. Each device typically includes its own charger including a “charge nut”, having a transformer, a rectifier, and smoothing and regulating circuits, which is plugged into a wall receptacle and a plug that is adapted to be connected to the device in order to charge a battery located therein. The charger converts the 110 V AC to, for example 4.8 or 9.6 V DC, at the required amperage for charging. Additional battery voltage monitoring circuits can be provided that shut off or put the charger in a battery maintenance mode when the battery is charged. Some receptacles utilize a USB plug for charging; however, others use proprietary plug designs. Typically, the charge nuts, cords and plugs for each device are thrown in a drawer or scattered on a desk or countertop for use and appear unsightly and are difficult to organize when cords become tangled between the various devices.

It would be desirable to provide a means for organizing and charging various portable devices in an organized and efficient manner. There is still room for improvement in the art.

### SUMMARY

Briefly stated, a charging station is provided that includes a base having a housing with at least one receptacle that is adapted to be connected to an external power source, with an outer cover being connected to the base and having a holder for one or more devices which need recharging. Preferably, the cover has a wave-shaped form which holds one or more devices which require charging in one or more wave-like supports on the cover. A slot is provided at the base of each wave-shaped support for receiving the device adapter plug, and a space is defined beneath the outer cover that allows the charger nut connected to the receptacle to be covered by the outer cover when it is in a closed position. Preferably, a cord organizer is provided with each receptacle so that the excess cord from the charger for the one or more devices which are connected to the charging station can be organized and stored in a compact and efficient manner.

In another aspect, a portable charge base is provided for use in connection with the charging station. The portable charge base includes a housing which encloses a battery compartment that includes a plurality of rechargeable batteries. External contacts which are adapted to contact mating contacts on the charging station are provided on the portable charge base. Preferably, the charging station is adapted to be placed on the portable charge base and the mating contacts on the charging station engage the contacts on the portable charge base. In a preferred embodiment, indicator lights are provided indicating the charge state of the portable charge base.

In another aspect, the invention provides a number of receptacle assemblies which include a top support for a receptacle that receives a plug, as well as a support stand which organizes the cord from a charger that is plugged into the receptacle. The shape of the top support can be varied for various plug configurations for the receptacle as well as various aesthetic appearances. The support stand for the receptacle support can also have various configurations which allow a charger cord to be wrapped thereabout in an organized manner.

The invention provides various different styles of device supports on the outer cover in order to support one or more portable devices, which are all generally referred to as “wave-shaped supports.” A charging station with a single support or charging stations with two or more supports can be provided for charging one or more portable electronic devices at the same time.

In another aspect, the invention can provide charging circuitry located within the charging station which senses a correct charging voltage for a portable device and provides the correct voltage to the portable device being charged.

The above-noted elements can be used alone or in combination with various other ones of the elements to provide charging stations with various configurations and functionality.

### BRIEF DESCRIPTION OF THE DRAWINGS

The foregoing summary as well as the following detailed description will be better understood when read in conjunction with the appended drawings. In the drawings preferred embodiments of the invention are illustrated.

FIG. 1 is a perspective view of a first embodiment of a charging station.

FIG. 2 is a perspective view of the charging station of FIG. 1 with the outer cover shown in the open position.

FIG. 3 is a perspective view of the charging station of FIG. 1.

FIG. 4 is a front view of the charging station of FIG. 3.

FIG. 5 is a left side elevational view of the charging station of FIG. 3.

FIG. 6 is a top view of the charging station of FIG. 3 shown with the outer cover in the closed position.

FIG. 7 is an elevational view of a portable charge base used in connection with the charging station of FIG. 3.

FIG. 8 is a left-side elevational view of the portable charge base of FIG. 7.

FIG. 9 is a perspective view with the outer cover shown in the open position of the charging station of FIG. 1 shown without the portable charge base.

FIG. 10 is a rear perspective view showing the charging station in FIG. 9 with the power cord extending there from.

FIG. 11 is a detailed view showing a receptacle assembly inside the charging station of FIGS. 1-3 and 9 shown with a charging cord installed thereon.

FIG. 12 is a view showing the bottom of the charging station 10 being installed onto the portable charge base.

FIG. 13 is a front elevational view of the portable charge base.

FIG. 14 is a top view of the portable charge base.

FIG. 15 is a bottom perspective view of the portable charge base with the battery cover opened to show the battery compartment with batteries located therein.

FIG. 16 is a view looking down on the inner cover of the charging station when the outer cover is opened in order to show a first receptacle configuration.

FIG. 17 is a view similar to FIG. 16 showing a second receptacle configuration.

FIG. 18 is a view similar to FIG. 16 showing a third receptacle configuration.

FIG. 19 shows a first embodiment of a clip which is connected to the bottom of the top support for holding a phone adapter plug in position.

FIG. 20 is an alternate embodiment of the clip connected to the bottom of the outer cover to hold the device adapter plug in position.

FIG. 21 is a perspective view of a second embodiment of a charging station in accordance with the present invention.

FIG. 22 is a perspective view similar to FIG. 21 of the second embodiment of the charging station.

FIG. 23 is a front elevational view of the charging station of FIG. 22.

FIG. 24 is a left side elevational view of the charging station of FIG. 22.

FIGS. 25-28 show a first embodiment of a receptacle assembly used in conjunction with the charging stations according to the present invention.

FIGS. 29-31 show a second embodiment of the receptacle assembly used with the charging stations according to the present invention.

FIGS. 32-34 show a third embodiment of a receptacle assembly used with the charging stations according to the present invention.

FIGS. 35-36 show a fourth embodiment of the receptacle assembly for use with the charging station according to the present invention.

FIG. 37 is a perspective view of a third embodiment of a charging station according to the present invention.

FIG. 38 is a perspective view of a fourth embodiment of a charging station according to the present invention.

FIG. 39 is a perspective view of a fifth embodiment of a charging station according to the present invention.

FIG. 40 is a perspective view of a sixth embodiment of a charging station in according to the present invention.

FIG. 41 is a perspective view of a seventh embodiment of a charging station in accordance with the present invention.

FIG. 42 is a perspective view of an eighth embodiment of a charging station in accordance with the present invention.

### DETAILED DESCRIPTION OF THE PREFERRED EMBODIMENTS

Certain terminology is used in the following description for convenience only and is not considered limiting. Words such as “front,” “back,” “top,” “bottom,” “left,” and “right” designate direction in the drawings to which reference is made. This terminology includes the words specifically noted above, derivatives thereof, and words of similar import. Additionally, the terms “a” and “one” are defined as including one or more of the referenced item unless specifically noted. The phrase “at least one of” followed by a list of two or more items, such as “A, B or C,” means any individual one of A, B or C, as well as any combination thereof.

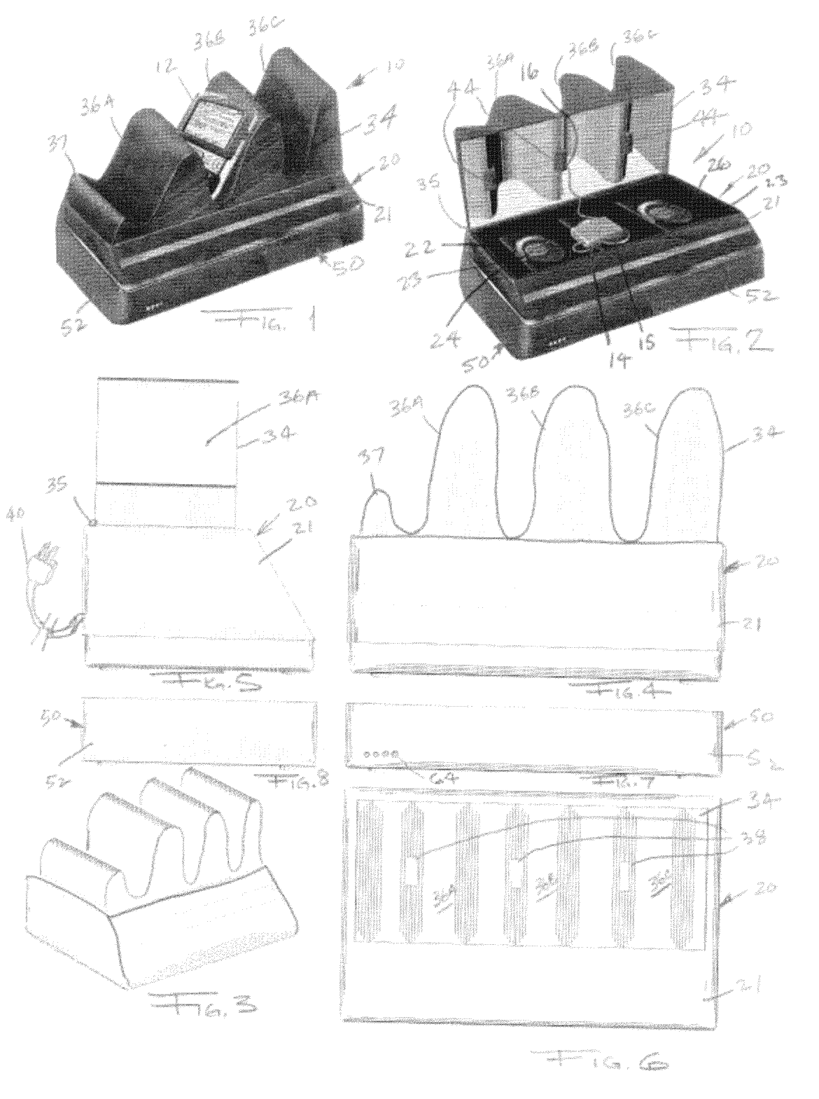

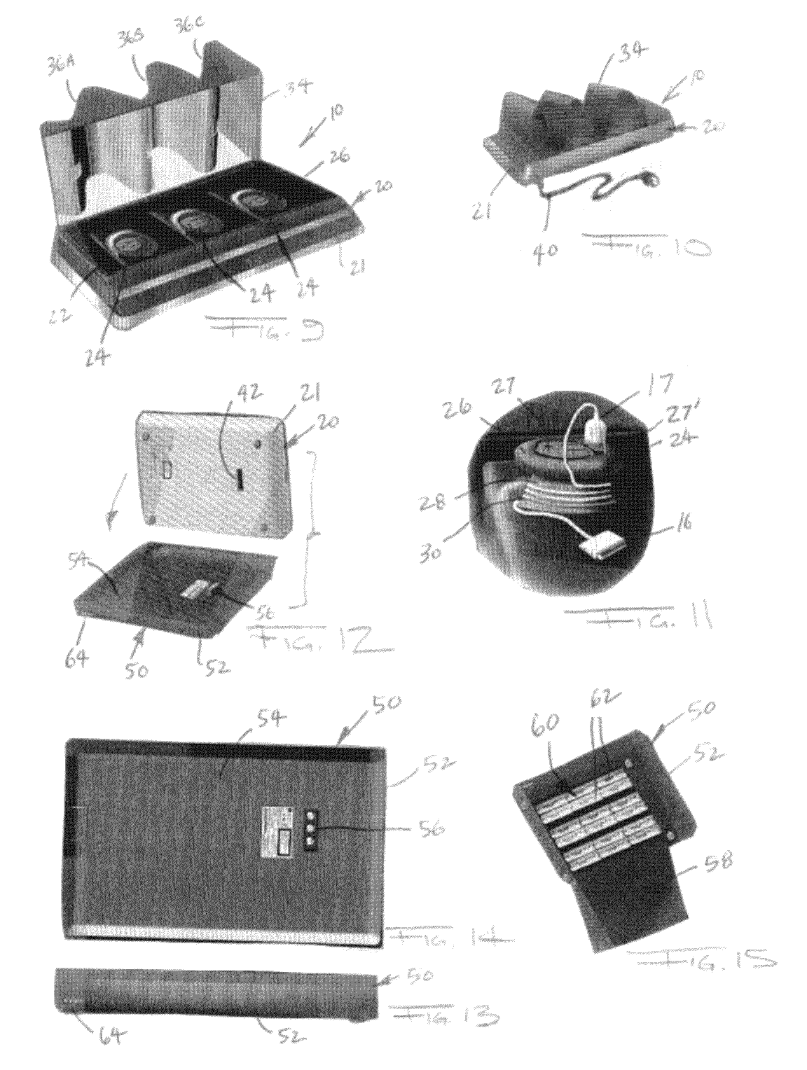

Referring to FIGS. 1-15, a first embodiment of a charging station 10 in accordance with the present invention is shown. The charging station 10 is illustrated in FIGS. 1 and 2 with the charging station base 20 connected to a portable charge base 50 which allows the entire charging station 10 to be used away from an external power supply such as house current. The charging station 10 is used to charge portable electronic devices, such as the cell phone 12 illustrated in FIG. 1. The charging station 10 includes the charging station base 20 having a housing 21, preferably formed of a polymeric material. This can be a molded housing or can be constructed from multiple pieces that are connected together in order to form the housing 21.

As shown in FIG. 2, an inner cover 22 is provided on top of the housing 21 which, in the position of use shown in FIG. 1, is covered by an outer cover 34. The inner cover 22 includes openings 23 in which receptacle assemblies 24 are located. The first embodiment of the charging station 10 shows three openings 23 in which three receptacle assemblies 24 are located. However, those skilled in the art will recognize that the invention relates to the use of at least one receptacle assembly 24 within a charging station 10, although 2, 3 or more receptacle assemblies 24 can be provided.

Referring to FIG. 11, the receptacle assembly 24 is shown in detail and includes a top support 26 with at least one plug 27. In the first preferred embodiment, two plugs are provided with the first plug 27 being for standard house current (120 V AC) and the second plug 27′ being for a USB connection. Various other plug configurations could also be utilized. The top support 26 is located on a support stand 28 which includes a cord wrap surface 30. In the first preferred embodiment, the cord wrap surface 30 includes grooves 32 which allow for easier winding of the cord, which in this case is illustrated as the USB cord 17 which includes the phone adapter plug 16 located on one end.

Located within the charging station base 20 is preferably a transformer, rectifier, and smoothing and regulating electronics for converting 120 V AC house voltage to the required DC charging voltage which in the preferred embodiment is 4.8 volts DC. Those skilled in the art will recognize that various known charging circuits and components can be used, and the invention is not limited to a particular charging circuit or components. This is connected to the charging contacts of the USB plug 27′ in the receptacle assembly 24. A cord 40 shown in FIG. 10 preferably extends from the back of the housing 21 and can be plugged into a known power outlet from an external source.

Referring again to FIGS. 1-6, 9 and 10, the outer cover 34 is preferably hinged via a hinge 35 to the housing 21 of the charging station base 20. The outer cover 34 preferably has a wave-like form with at least one wave-shaped support 36A, and in the first preferred embodiment, three wave-shaped supports 36A, 36B and 36C which can support portable electronic devices. A smaller height retaining bump 37 is provided in front of the first support 36A to catch the bottom of the phone 12 or other portable electronic device and hold it in position.

As shown in FIG. 6, slots 38 are provided at the base of each of the wave-shaped supports 36A, 36B, 36C through which the phone adapter plug 16 from a standard charger 14 is inserted such that it protrudes to the outer surface of the outer cover 34. This is best shown in FIG. 2. The phone adapter plug 16 is preferably held in place using a clip 44 or 44′, as shown in FIGS. 19 and 20, which hold the plug and a short amount of cord to the underside of the outer cover 34 in proximity to the slots 38. In the first preferred embodiment, the receptacle assemblies 24 include both a plug 27 for 110 volts AC current which the charger 14 for a portable electronic device or cell phone 12 can be inserted. The cord 15 is then threaded into position into the desired slot 38 and held in place using a clip 44 or 44′. A user can then insert the phone adapter plug 16 located on the end of the cord 15 into the mating receptacle on the phone 12 or portable electronic device so that it can be charged while sitting in position on one of the wave-shaped supports 36A, 36B, 36C. In the first preferred embodiment of the charging station 10, up to three portable electronic devices can be placed on the charging station 10. Additionally, if charging can be accomplished via a USB cord 17, as illustrated in FIG. 11, this can be plugged into the USB plug 27′ which is connected to a charging circuit (not shown) located within the charging station base 20 which converts the 110 volts AC to the proper DC voltage for charging, preferably 4.8 volts DC.

The hinged outer cover 34 is preferably molded from a polymeric material; however, it can be made from other suitable materials. While in the first preferred embodiment, a hinge 35 used to connect the outer cover 34 to the housing 21, this connection could be made merely by placing it in position without any hinge or other connection or via appropriate snaps or detents instead of the hinge 35.

Referring to FIGS. 7, 8 and 12-15, in the first preferred embodiment, a portable charge base 50 is provided. The portable charge base 50 includes a housing 52 having an upper surface, shown in detail in FIGS. 12 and 14, with a recess in which the bottom of the housing 21 of the charging station base 20 can be received. A connector 56 for connecting the portable charge base 50 to the charging station base 20 is provided and preferably, as shown in FIG. 12, a mating receptacle 42 is provided on the bottom of the housing 21 for the charging station base 20 such that when the charging station base 20 is placed on the portable charge base 50, it receives the connector 56 and power is transmitted to the charging station base 20.

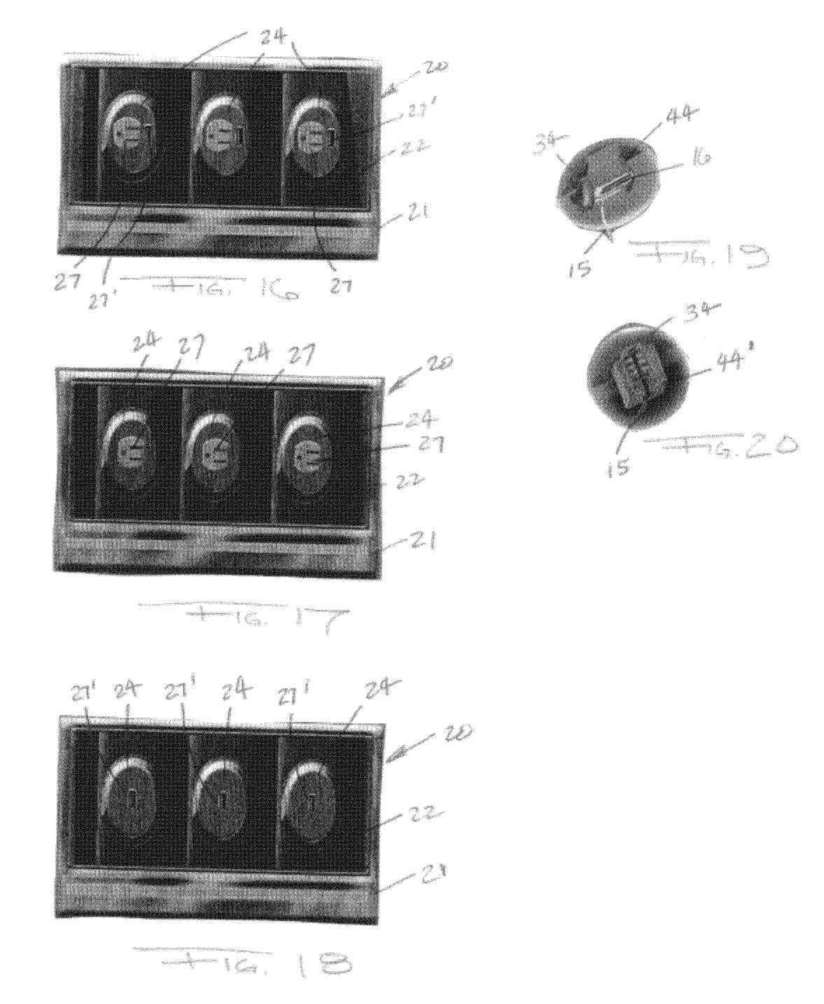

As shown in FIG. 15, the portable charge base 50 includes a bottom cover 58 which covers a battery compartment 60 located in the housing 52. Rechargeable batteries 62 are located within the battery compartment 60 and are electrically connected to the contacts 56. The rechargeable batteries 62 can be charged separately, and then used to provide power to the charging station 10 when the charging station base 20 is installed on the portable charge base 50 in the event that an outside power source, such as house current, is not available. A separate charging circuit (not shown) for charging the battery 62 is preferably located within the housing 52 and a plug or cord can be provided for recharging the batteries 62 in the portable charge base 50. In the event that the portable charge base 50 is used, preferably a control circuit is provided in the charging station base 20 in order to control the charging voltage and amperage from the portable charge base 50 to the proper DC voltage and amperage for charging the portable electronic device, such as the cell phone 12.

Referring to FIGS. 16-18, three different configurations for the receptacle assemblies 24 used in connection with the first embodiment of the charging station 10 are shown. In FIG. 16, the receptacle assemblies 24 include the standard plug 27 as well as a USB plug 27′. In FIG. 17, only the standard plug 27 is provided for each receptacle assembly 24. In FIG. 18 only the USB plug 27′ is provided in each receptacle 24. Those skilled in the art will recognize that other plug configurations could also be provided using various different plugs for different applications, if desired.

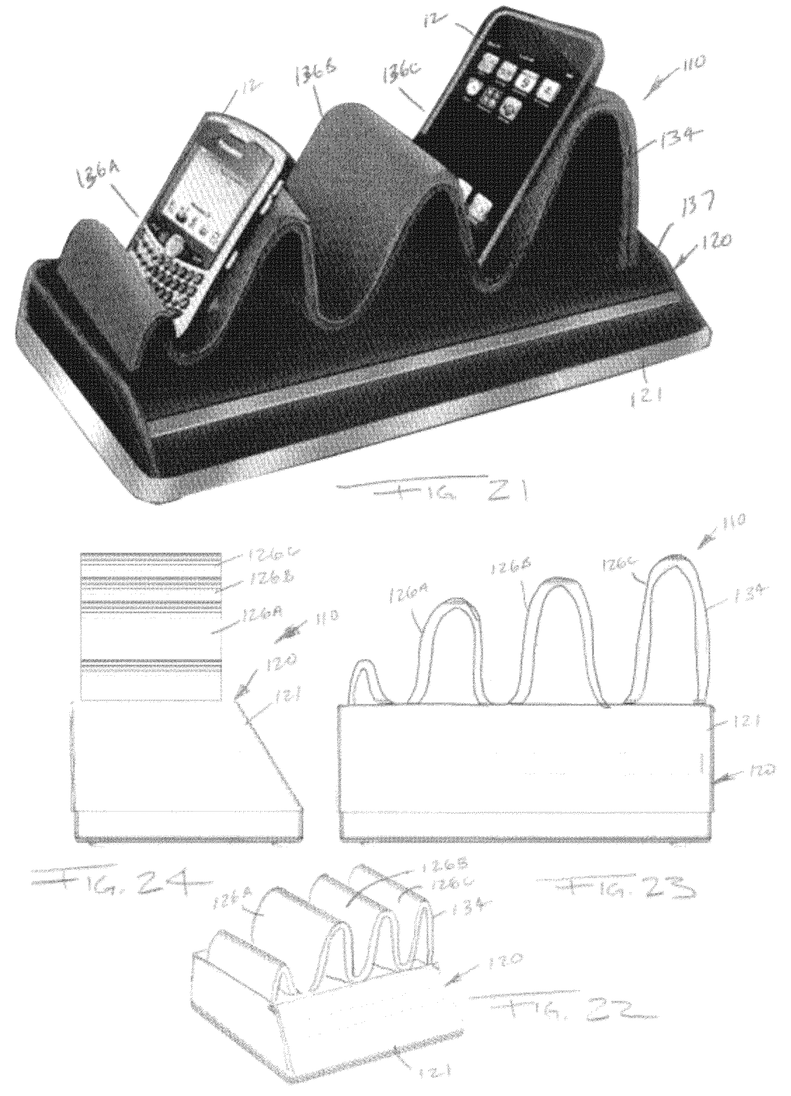

Referring to FIGS. 21-24, a second embodiment 110 of the charging station is shown. The second embodiment of the charging station 110 is similar to the first embodiment of the charging station 10 and similar items have been identified with the same element numbers increased by 100. The items which are not separately identified are the same as the first embodiment of the charging station 10.

In the second embodiment of the charging station 110, the outer cover 134 includes wave-shaped phone supports 136A, 136B, 136C which are open on the sides. The wave supports rest on a cover 137 which is preferably hinged to the housing 121 of the charging station base 120. As shown in FIG. 23, each support 136A, 136B, 136C increases in height from the prior support providing a different look as well as the ability to support different sized portable electronic devices. While three of the supports 136A, 136B, 136C are shown, those skilled in the art will recognize that 1, 2, or 4 or more supports could be provided. The charging station 110 functions in the same manner as the charging station 10, and can be used with the portable charge base 50.

Referring now to FIGS. 25-28, a second embodiment of the receptacle assembly 24′ is shown. In the second embodiment of the receptacle assembly 24′, the top support 26′ is shown with a single plug 27 which is adapted to be connected to the standard 120 volt AC house current via the power cord 40. Here the support stand 28 has the cord wrap surface 30 with grooves 32, which are provided in a generally cylindrical form. The receptacle assembly 24′ is preferably for use with the charging stations according to the invention. However, those skilled in the art will recognize that the receptacle assembly 24′ can be used in other electrical devices where it is necessary to control or store excess power cords.

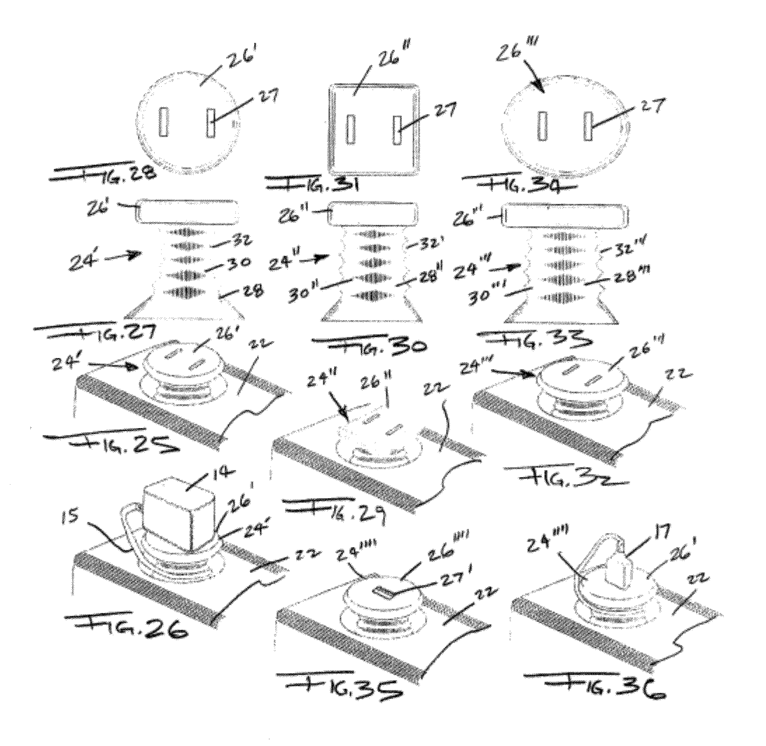

Referring to FIGS. 29-31, a third embodiment of the receptacle assembly 24″ is shown. Here, the top support 26″ is also shown with a standard plug 27. However, the shape of the top support 26″ is generally rectilinear. In this case, the support stand 28″ is also generally rectilinear in form and includes a cord wrap surface 30 with grooves 32. The generally rectilinear form of the support stand is preferably rounded at the corners to allow for easier wrapping of the cord around the support stand 28″.

Referring to FIGS. 32-34, a third embodiment of the receptacle assembly 24′″ is shown. Here the top support 26′″ is oval in form and is located on a generally cylindrical support stand 28′″ which also includes the cord wrap surface 30′″ having grooves 32′″.

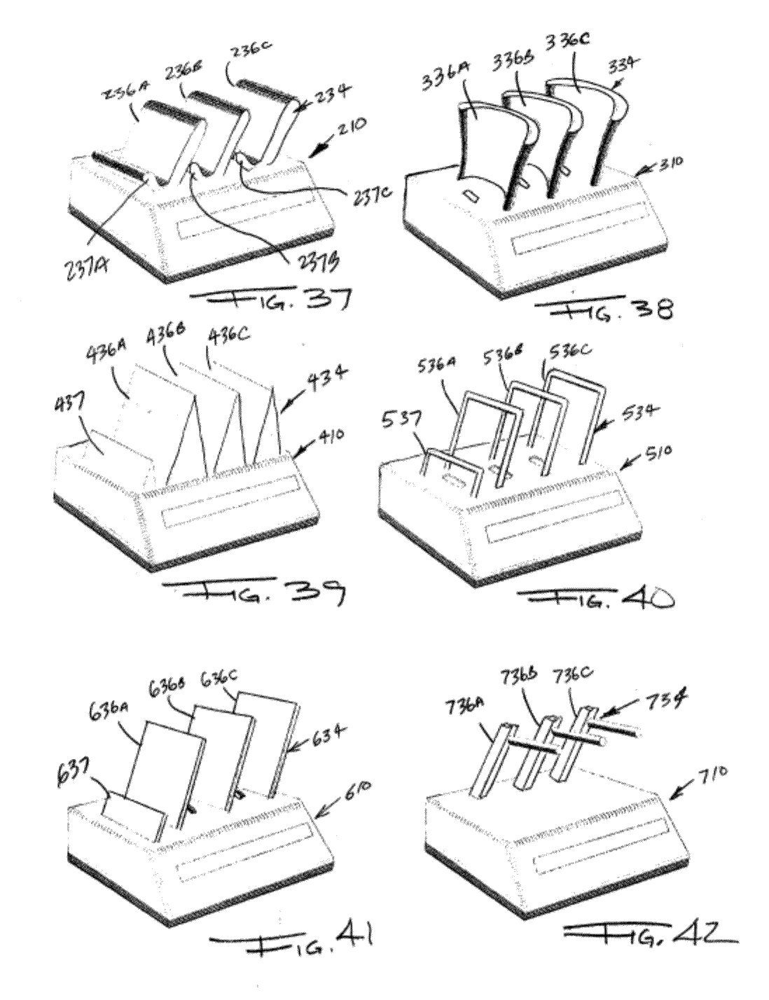

Referring to FIGS. 35 and 36, the receptacle assembly 24″ is provided except in this embodiment it only includes the USB plug 27′ for a USB cord 17.

Referring now to FIGS. 37-42, six additional embodiments of the charging station are shown. The functionality of these additional charging stations is the same as the charging station 10 and all that has been changed is the phone supports located on the outer cover. Accordingly, only these differences will be described in connection with the embodiments below.

Referring to FIGS. 37, the third embodiment of the charging station 210 includes an outer cover 234 having spaced apart supports 236A, 236B, 236C each of which include an angled support surface as well as a separate stop 237A, 237B, 237C for holding the bottom of the portable electronic device in position. Preferably, the supports 236A, 236B, 236C are angled at an angle of between 45° and 75° and more preferably are angled at an angle of approximately 60°. This provides sufficient support to keep the portable electronic device in position while allowing good visibility for a user wishing to see each of the devices being held on the charging station 210.

In FIGS. 38, the fourth embodiment of the charging station 310 includes an outer cover 334 having three phone supports 336A, 336B, 336C which are generally C-shaped in cross section. These provide a cradle-like hold for the portable electronic device which is being charged on the portable charging station 310.

Referring to FIG. 39, a fifth embodiment of the charging station 410 is shown. Here the outer cover 434 includes supports 436A, 436B, 436C that are triangular in cross-section, with an additional smaller triangular-shaped front support 437 that is located in front of the first support 436A to hold the bottom of the first portable electronic device which is placed on the first support.

Referring to FIG. 40, the sixth embodiment of the charging station 510 includes an outer cover 534 having supports 536A, 536B, 536C each having a generally U-shaped form with the cross member between the U-legs providing the support for the portable electronic device. A smaller U-shaped support is provided in front of the first support 536A to hold the bottom of a first portable electronic device placed on the first support.

Referring to FIG. 41, the seventh embodiment of the charging station 610 is shown with the outer cover 634 including generally planar supports 636A, 636B, 636C as well as a smaller front support 637 to hold the bottom of the first device placed on the first support 636A. Preferably, these supports are set at an angle of between 45° and 75° and more preferably at an angle of approximately 60°.

Referring to FIG. 42, the eighth embodiment of the charging station 710 is shown. Here, the outer cover 634 includes L-shaped supports 736A, 736B, 736C, with the cross member of each of the L-shaped supports being spaced from the surface of the cover and providing a support for the back of a portable electronic device.

Those skilled in the art will recognize that each of the embodiments of the charging station could be provided with one or more receptacle assemblies or one or more supports to allow charging of one or more portable electronic devices in an organized and efficient manner. Further, the receptacle assemblies can be used in other applications for power cord management.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A portable charging station, comprising:
a charging station base including at least one receptacle assembly having a top support with a plug located on a support stand having a cord wrap surface;
an outer cover located on the charging station base, the outer cover having at least one portable electronic device support as well as a slot located through the outer cover in proximity to the support adapted to receive a charger plug from a charging device; and
a connection to an outside power source connected to the receptacle assembly.

2. A charging station according to claim 1 further comprising said outer cover having a plurality of wave shaped supports.

3. A charging station according to claim 1 further comprising said cord wrap surface having grooves.

4. A charging station according to claim 1 further comprising having a transformer, rectifier, and smoothing and regulating electronics for converting 120 V AC into DC charging voltage.

5. A charging station according to claim 1 further comprising having a plurality of receptacle assemblies with said charger plugs being one or more of a group of USB plug, 120 V AC plug or proprietary plug designs.

6. A charging station according to claim 1 further comprising having said outer cover connected to the housing by a hinge.

7. A charging station according to claim 1 further comprising having said charging station base having a bottom cover that covers a battery compartment in the housing.

8. A charging station according to claim 7 further comprising having said battery compartment is used to charge rechargeable batteries.

9. A charging station according to claim 1 further comprising having said where the outer cover has a wave shaped form.

10. A charging station according to claim 9 further comprising having a retaining bump in front of the support.

11. A method to charge electronic devices, comprising:
portable charging station a charging station base including at least one receptacle assembly having a top support with a plug located on a support stand having a cord wrap surface;
an outer cover located on the charging station base, the outer cover having at least one portable electronic device support as well as a slot located through the outer cover in proximity to the support adapted to receive a charger plug from a charging device; and
a connection to an outside power source connected to the receptacle assembly.

12. A method according to claim 11 further comprising said outer cover having a plurality of wave shaped supports.

13. A method according to claim 11 further comprising said cord wrap surface having grooves.

14. A method according to claim 11 further comprising having a transformer, rectifier, and smoothing and regulating electronics for converting 120 V AC into DC charging voltage.

15. A method according to claim 11 further comprising having a plurality of receptacle assemblies with said charger plugs being one or more of a group of USB plug, 120 V AC plug or proprietary plug designs.

16. A method according to claim 11 further comprising having said outer cover connected to the housing by a hinge.

17. A method according to claim 11 further comprising having said charging station base having a bottom cover that covers a battery compartment in the housing and having said battery compartment is used to charge rechargeable batteries.

18. A method according to claim 11 further comprising having said where the outer cover has a wave shaped form.

19. A method according to claim 18 further comprising having a retaining bump in front of the support.

20. A portable charging station, comprising:
a charging station base including at least one receptacle assembly having a top support with a plug located on a support stand having a cord wrap surface said cord wrap surface has grooves;
an outer cover located on the charging station base where the outer cover has a wave shaped form and is connected to the housing by a hinge, the outer cover having at least one portable electronic device wave shaped support with a retaining bump in front of the support as well as a slot located through the outer cover in proximity to the support adapted to receive a charger plug from a charging device; and
a connection to an outside power source connected to the receptacle assembly.
